(19) United States
(12) Patent Application Publication
(10) Pub. No.: US 2024/0309680 A1
(43) Pub. Date: Sep. 19, 2024

(54) INTERLOCKING APPARATUS AND DRAWER CABINET

(71) Applicant: Fuqing Xinghongxin Furniture Co., Ltd., Fuqing (CN)

(72) Inventor: Wenxian TAN, Fuqing (CN)

(21) Appl. No.: 18/448,931

(22) Filed: Aug. 12, 2023

(30) Foreign Application Priority Data
Mar. 13, 2023 (CN) 202310236748.0

(51) Int. Cl. E05B 65/463

(52) U.S. Cl. CPC E05B 65/463

(57) ABSTRACT

An interlocking apparatus includes an interlocking component and at least two drawer side panels. The drawer side panels are arranged vertically. A sliding groove is formed on each of the at least two drawer side panels. The sliding groove comprises a locking segment and a sliding segment, with the locking segment being communicated with the sliding segment. The locking segment is vertically positioned, with a lower portion of the locking segment communicated with and connected to a starting portion of the sliding segment. The sliding segment is inclined upwards along a depth direction of a drawer. Each of the drawer side panels is slidably connected to the interlocking component via the sliding groove. When one of the drawer side panels is located within the sliding segment of one sliding groove, the remaining drawer side panels are located within the locking segments of the corresponding sliding grooves.

### FIELD OF THE DISCLOSURE

The present disclosure relates to the technical field of cabinetry, specifically focusing on an interlocking apparatus and a drawer cabinet.

### BACKGROUND OF THE DISCLOSURE

There are publicly available technological solutions for locking drawer cabinets, such as the Chinese patent No. CN202262657U which is entitled “Furniture Interlocking Structure”. This disclosure employs a stopper installed on the side panel of the drawer and a locator on the locking rod to achieve interlocking functionality when the drawer is pulled out. However, this interlocking solution not only has a complex structural design, but also requires intricate assembly. Furthermore, the elastic component in the locator is prone to damage due to the repetitive daily use of pulling and locking the drawer, resulting in a loss of interlocking functionality and imposing maintenance burden on the users.

### SUMMARY OF THE DISCLOSURE

In order to address the aforementioned issue, the objective of this invention is to provide an interlocking apparatus that enables users to open one drawer while simultaneously locking the other drawers when using a multi-layer drawer cabinet. This enhances the stability of drawer usage, and the structural design is ingeniously crafted, reducing the amount of components and assembly complexity. This makes it suitable for mass production, significantly lowering the cost of production.

To achieve the aforementioned objectives, the following interlocking apparatus and drawer cabinet are disclosed.

An interlocking apparatus includes an interlocking component and at least two drawer side panels. The drawer side panels are arranged vertically from top to bottom. A sliding groove is formed on each of the drawer side panels. The sliding groove includes a locking segment and a sliding segment, with the locking segment being communicated with the sliding segment. The locking segment is vertically positioned, with a lower portion of the locking segment communicated with and connected to a starting portion of the sliding segment. The sliding segment is inclined upwards along a depth direction of the drawer. Each of the drawer side panels is slidably connected to the interlocking component via the sliding groove. When a connection position of the interlocking component with one of the drawer side panels is located within the sliding segment, the connection positions of the interlocking component with the remaining drawer side panels are/is all within the locking segment of the corresponding sliding groove.

In some embodiments, the interlocking component includes a locking rod, a locking rod guide, and at least two fixed blocks. The locking rod is movably positioned along a length direction within the locking rod guide. The fixed blocks are spaced and arranged along the length direction of the locking rod. The fixed blocks are slidingly attached to the sliding groove.

In some embodiments, each of the fixed blocks includes a cylindrical pin, and the cylindrical pin is slidingly attached to the sliding groove.

In some embodiments, the interlocking apparatus includes at least two locking rod guides.

In some embodiments, the sliding segment is a straight sliding groove or a curved sliding groove.

In some embodiments, the sliding groove further includes a descending segment. The locking segment, the sliding segment, and the descending segment are in communication with each other successively. An opening is arranged at a terminal portion of the descending segment.

Based on the same inventive idea, the present invention further provides a drawer cabinet using the aforementioned interlocking apparatus. The drawer cabinet includes a cabinet body, at least two drawers arranged longitudinally, and the aforementioned interlocking apparatus. The interlocking component is arranged on a side panel of the cabinet body. The sliding groove is arranged on one drawer side panel of each drawer. When the connection position of the interlocking component with one drawer side panel is located in the sliding segment of the sliding groove, the connection positions of the interlocking component with the remaining drawer side panels are all located within the locking segment of the corresponding sliding groove.

The present invention provides the following advantages.

1. The drawers equipped with the interlocking apparatus of this invention ensure enhanced safety and stability during use, as only one drawer can be pulled out at a time while the rest remain locked and cannot be pulled out.

2. The interlocking apparatus of this invention, achieved by incorporating sliding grooves on the drawer side panels and lock components in the cabinet side panel, boasts clever structural design, convenient assembly, time-saving and labor-saving benefits. The drawer side panel with a sliding groove can also be mass-produced, further reducing production costs, and holds promising prospects for application.

3. The lock components used in the interlocking apparatus of this invention, including only one lock rod, lock bar guides, and fixed blocks, are minimal in parts, easy to install, and require simple operations to assembly and adjust the interlocking components and the sliding grooves.

4. In addition to sharing the same advantages as the interlocking apparatus, the drawer cabinet of this invention also offers the flexibility of setting the interlocking features according to actual needs.

### BRIEF DESCRIPTION OF DRAWINGS

In order to clarify the embodiments of the present disclosure, the accompanying drawings required for embodiments will be briefly described below. It should be understood that the following drawings only illustrate some embodiments of the present disclosure and should not be deemed as limiting the scope of patent protection. Other drawings may be obtained by skilled persons in the art without inventive effort based on the drawings of the present disclosure.

FIG. 1 is a schematic diagram of the interlocking component and the drawer side panels according to embodiments of the present invention.

FIG. 2 is a perspective elevational view of the drawer side panel according to embodiments of the present invention.

FIG. 3 is a front elevational view of the drawer side panel according to embodiments of the present invention.

FIG. 4 is a schematic diagram of the interlocking component.

FIG. 5 is a schematic diagram of the drawer being pulled out according to embodiments of the present invention.

In the drawings:

10—interlocking component; 11—locking rod; 12—locking rod guide; 13—fixed block; 131—cylindrical pin; 20—drawer side panel; 21—sliding groove; 211—locking segment; 212—sliding segment; 213—descending segment; 100—cabinet body; 200—drawer; 300—sliding rail.

### DETAILED DESCRIPTION OF THE DISCLOSURE

The present invention will be described clearly and completely below accompanied with the drawings and detailed embodiments.

### Embodiment One

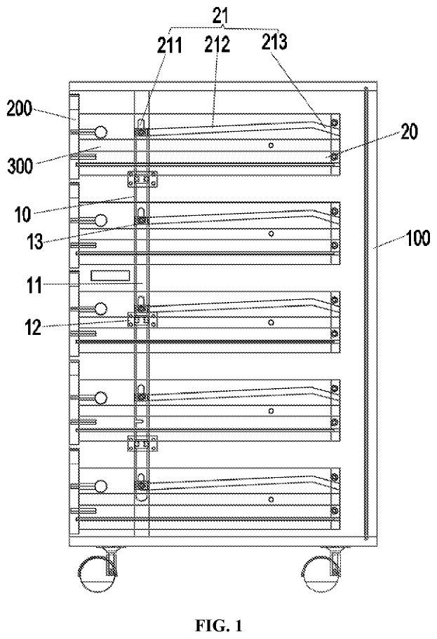

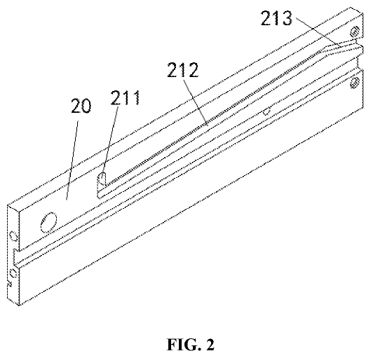

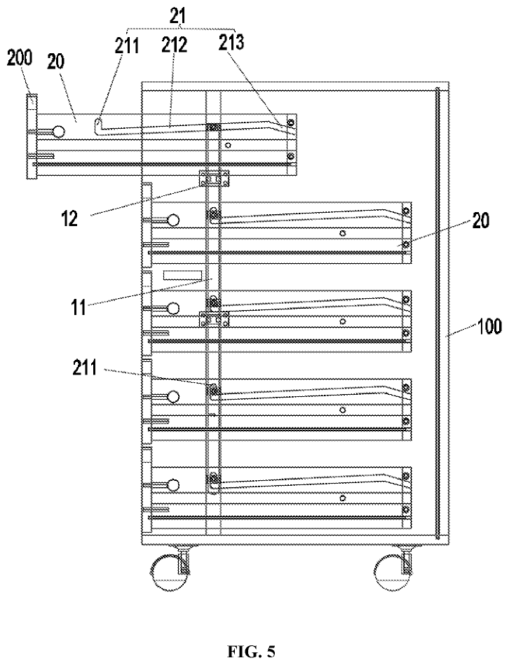

Please refer to FIG. 1 to FIG. 5, depicting an interlocking apparatus including an interlocking component 10 10 and at least two drawer side panels 20. The drawer side panels 20 are arranged vertically from top to bottom. A sliding groove 21 is formed on each of the drawer side panels 20. The sliding groove 21 includes a locking segment 211 and a sliding segment 212, with the locking segment 211 being communicated with the sliding segment 212. The locking segment 211 is vertically positioned, with a lower portion of the locking segment 211 communicated with and connected to a starting portion of the sliding segment 212. The sliding segment 212 is inclined upwards along a depth direction of the drawer 200. Each of the drawer side panels 20 is slidably connected to the interlocking component 10 via the sliding groove 21. Notably refer to FIG. 5, when a connection position of the interlocking component 10 with one of the drawer side panels 20 is located within the sliding segment 212, the connection positions of the interlocking component 10 with the remaining drawer side panels 20 are/is all within the locking segment 211 of the corresponding sliding groove 21.

Notably refer to FIG. 1 and FIG. 5, the cabinet body 100 using the aforementioned interlocking apparatus includes at least two drawers 200 arranged vertically. In practical applications, the interlocking component 10 is mounted on the side panel of the cabinet body 100 generally. When one of the drawers 200 is pulled out, the connection positions of the remaining drawers with the interlocking component 10 will be changed from a lower portion of the locking segment 211 to the sliding segment 212 gradually. This change makes the interlocking component 10 to ascend vertically without causing any horizontal displacements. At the same time, the remaining drawers 200, which are not pulled out, are locked, because the interlocking components is caused to move upwardly, and there are no horizontal displacements between the interlocking component 10 and those remaining drawers 200. Accordingly, the connection positions between the interlocking component 10 and sliding grooves 21 of the drawer side panels 20 of the unpulled drawers are changed into the corresponding locking segments 211. Since the movable direction of the sliding groove 21 is perpendicular to the pull direction of the drawers 200, the movement of the drawer 200 along the pull direction will be blocked when the connection position of the interlocking component 10 with the drawer side panel 20 is located within the locking segment 211. By doing so, the remaining unpulled drawers 200 can be blocked, avoiding more than one drawers 200 from being pulled out at the same time. This definitely improves the safety stability of using the cabinet 100.

Please refer to FIG. 4, there are multiple embodiments for the interlocking component 10. In the present embodiment, the most simple and easy-to-install embodiment is provided. However, the interlocking component 10 is not limited by this embodiment. The interlocking component 10 includes a locking rod 11, a locking rod guide 12, and at least two fixed blocks 13. The locking rod 11 is movably positioned along a length direction within the locking rod guide 12. There are two locking rod guides 12 in this embodiment. The number of the locking rod guide can be varied according to the number of the drawers 200. The greater the quantity of drawers 200, the longer the length of the locking rod, and consequently, the number of the locking rod guide 12 used shall also increase. In this embodiment, as shown in FIG. 1, three locking rod guides 12 are used. The fixed blocks 13 are spaced and arranged along the length direction of the locking rod 11. The fixed blocks 13 are slidingly attached to the sliding groove 21. More particularly, each of the fixed blocks 13 includes a cylindrical pin 131, and the cylindrical pin 131 is slidingly attached to the sliding groove 21.

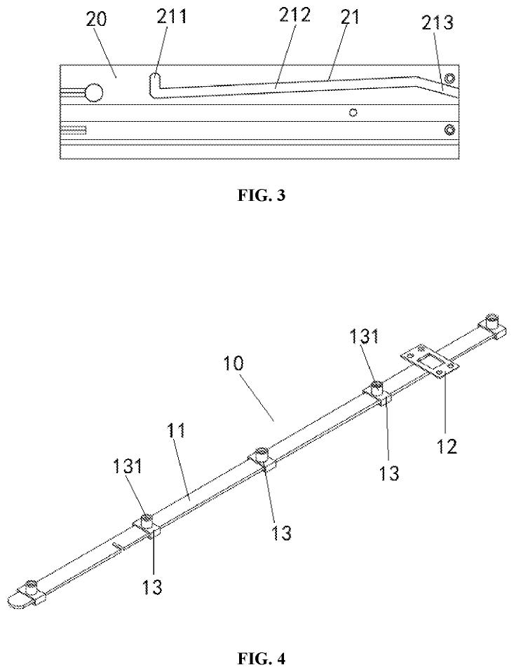

Specifically, the sliding segment 212 is a straight sliding groove 21 or a curved sliding groove 21, both allowing the locking rod 11 to ascend. Accordingly, both designs can be used as the embodiments of the sliding segment 212 of the sliding groove 21 of the present invention. Please refer to FIG. 3 and FIG. 4, a terminal portion of the sliding groove 21 further includes a descend segment 213. The locking segment 211, the sliding segment 212, and the descending segment 213 are in communication with each other successively. An opening is arranged at a terminal portion of the descending segment 213. The descending segment 213 is provided in the present invention, so that users can pull out the drawers 200 entirely. This improves the flexibility of the drawers in use, facilitating users to clean drawers 200, reordering the drawers 200, and etc.

During use, as shown in FIG. 1 and FIG. 5, five drawers 200 are vertically arranged. The drawers 200 are movably attached to the cabinet body 100 via sliding rails 300, and therefore enabling the drawers 200 to be pulled out along the depth direction of the drawers. The sliding groove 21 is arranged on each of the drawer side panels 20. After the locking rod guide 12 and the locking rod are slidably connected, the locking rod guide 12 is anchored to the side panel of the cabinet body 100. Alternatively, the locking rod guide 12 is anchored to the side panel of the of the cabinet body 100, and then the locking rod 11 is inserted into the locking rod guide. According to the positions of the drawers 200, the mounting position of the fixed blocks 13 can be varied. The fixed blocks 13 is then attached to the sliding groove 21, and at last, the side panel of the cabinet body is secured.

The interlocking apparatus of the present invention not only improves the safety stability of the drawer cabinet during use, but also provides a smart and easy-to-install design with less components. The interlocking apparatus requires simple operations to assembly and adjust the interlocking components and the sliding grooves.

In addition to sharing the same advantages as the interlocking apparatus, the drawer cabinet of this invention also offers the flexibility of setting the interlocking features according to actual needs.

### Embodiment Two

Please refer to FIG. 1 to FIG. 5, depicting an interlocking apparatus including an interlocking component 10 10 and at least two drawer side panels 20. The drawer side panels 20 are arranged vertically from top to bottom. A sliding groove 21 is formed on each of the drawer side panels 20. The sliding groove 21 includes a locking segment 211 and a sliding segment 212, with the locking segment 211 being communicated with the sliding segment 212. The locking segment 211 is vertically positioned, with a lower portion of the locking segment 211 communicated with and connected to a starting portion of the sliding segment 212. The sliding segment 212 is inclined upwards along a depth direction of the drawer 200. Each of the drawer side panels 20 is slidably connected to the interlocking component 10 via the sliding groove 21. Notably refer to FIG. 5, when a connection position of the interlocking component 10 with one of the drawer side panels 20 is located within the sliding segment 212, the connection positions of the interlocking component 10 with the remaining drawer side panels 20 are/is all within the locking segment 211 of the corresponding sliding groove 21.

Preferably, the interlocking component 10 includes a locking rod 11, a locking rod guide 12, and at least two fixed blocks 13. The locking rod 11 is movably positioned along a length direction within the locking rod guide 12. The fixed blocks 13 are spaced and arranged along the length direction of the locking rod 11. The fixed blocks 13 are slidingly attached to the sliding groove 21. One embodiment of the fixed block 13 is as follows: the fixed block 13 includes a cylindrical pin 131, and the cylindrical pin 131 is slidingly attached to the sliding groove 21.

Preferably, the sliding segment 212 of the sliding groove 21 is a straight sliding groove 21 or a curved sliding groove 21,

In this embodiment, in the drawer cabinet, the interlocking apparatus can be installed for all drawers 200, or part of the drawers 200. For example, the bottom drawer 100 merely affects little stability to the cabinet body 100 when being pulled out, so that there might be no interlocking apparatus needed. In another example, according to actual needs, the drawers 200 may be connected to the interlocking apparatus with an interval.

The drawer cabinet according to this embodiment is a cabinet having the interlocking apparatus as described in Embodiment One. Accordingly, those features not detailed described in this embodiment can be found Embodiment One, and the present embodiment possesses similar advantages as Embodiment One.

The aforementioned is merely a specific embodiment of the present invention and does not limit the scope of the invention. Any equivalent structural modifications made based on the disclosure of the present invention, as well as direct or indirect applications in other relevant technical fields, shall be similarly included within the scope of the patent protection of the present invention.

What is claimed is:

1. An interlocking apparatus, comprising an interlocking component and at least two drawer side panels; the at least two drawer side panels are arranged vertically from top to bottom;
a sliding groove is formed on each of the at least two drawer side panels;
the sliding groove comprises a locking segment and a sliding segment, with the locking segment being communicated with the sliding segment;
the locking segment is vertically positioned, with a lower portion of the locking segment communicated with and connected to a starting portion of the sliding segment;\
the sliding segment is inclined upwards along a depth direction of a drawer;
each of the at least two drawer side panels is slidably connected to the interlocking component via the sliding groove;
when a connection position of the interlocking component with one of the at least two drawer side panels is located within the sliding segment, the connection positions of the interlocking component with the remaining drawer side panels are within the locking segment of the corresponding sliding groove.

2. The interlocking apparatus according to claim 1, wherein the interlocking component comprises a locking rod, a locking rod guide 12, and at least two fixed blocks;
the locking rod is movably positioned along a length direction within the locking rod guide 12;
the fixed blocks are spaced and arranged along the length direction of the locking rod;
the fixed blocks are slidingly attached to the sliding groove.

3. The interlocking apparatus according to claim 2, wherein each of the fixed blocks comprises a cylindrical pin, and the cylindrical pin is slidingly attached to the sliding groove.

4. The interlocking apparatus according to claim 2, wherein the interlocking apparatus includes at least two locking rod guide 12s.

5. The interlocking apparatus according to claim 1, wherein the sliding segment of the sliding groove is a straight sliding groove or a curved sliding groove.

6. The interlocking apparatus according to claim 1, wherein the sliding groove further includes a descending segment; the locking segment, the sliding segment, and the descending segment are in communication with each other successively; an opening is arranged at a terminal portion of the descending segment.

7. A drawer cabinet, comprising a cabinet body, at least two drawers arranged longitudinally, and the interlocking apparatus according to claim 1;
the interlocking component is arranged on a side panel of the cabinet body;
the sliding groove is arranged on one drawer side panel of each drawer;
when the connection position of the interlocking component with one drawer side panel is located in the sliding segment of the sliding groove, the connection positions of the interlocking component with the remaining drawer side panels are all located within the locking segment of the corresponding sliding groove.

8. The drawer cabinet according to claim 7, wherein the interlocking component comprises a locking rod, a locking rod guide 12, and at least two fixed blocks;
the locking rod is movably positioned along a length direction within the locking rod guide 12;
the fixed blocks are spaced and arranged along the length direction of the locking rod;
the fixed blocks are slidingly attached to the sliding groove.

9. The drawer cabinet according to claim 8, wherein each of the fixed blocks comprises a cylindrical pin, and the cylindrical pin is slidingly attached to the sliding groove.

10. The drawer cabinet according to claim 7, wherein the sliding segment of the sliding groove is a straight sliding groove or a curved sliding groove.
